(19) United States
(12) Patent Application Publication
(10) Pub. No.: US 2019/0322558 A1
(43) Pub. Date: Oct. 24, 2019

(54) Microbial Electrochemical Cell and direct salt recovery

(71) Applicant: Apoorva Goel, Mirdif (AE)

(72) Inventor: Apoorva Goel, Mirdif (AE)

(21) Appl. No.: 16/145,244

(22) Filed: Sep. 28, 2018

Related U.S. Application Data
(60) Provisional application No. 62/659,910, filed on Apr. 19, 2018.

(51) Int. Cl. C02F 3/00; C02F 1/52; C02F 3/34; C02F 1/42; H01M 8/16; C02F 1/461

(52) U.S. Cl. CPC C02F 3/005; C02F 1/52; C02F 3/341; C02F 1/42; C02F 2103/08; C02F 1/46109; C02F 2001/422; C02F 2001/425; H01M 8/16

(57) ABSTRACT

A method and apparatus for reducing brine effluent from desalination plants by modifying microbial electrochemical cells are disclosed. To reduce brine generation, the contaminant salts from saline water, such as seawater or wastewater, which are to be desalinated, are accumulated in two organic solvent solutions. The generated organic solvent solutions are then mixed in a container wherein the acids and alkalis combine to produce salts which precipitate out of the organic solvent solution due to low solubility. The method may employ bipolar membranes or cation exchange membranes and anion exchanges membranes. Some embodiments of this invention can be used to desalinate brine from any available source and reduce the operational cost of brine treatment.

### CROSS-REFERENCE TO RELATED APPLICATIONS

This application claims the benefit of the filing date of U.S. Patent Application No. 62/659,910, entitled “Microbial Electrolysis Cell and direct salt recovery”, filed on Apr. 19, 2018, the disclosures of which are incorporated by reference herein in their entireties.

### STATEMENT REGARDING FEDERALLY SPONSORED RESEARCH

Not Applicable.

### REFERENCE TO SEQUENCE LISTING, A TABLE, OR A COMPUTER PROGRAM LISTING COMPACT DISC APPENDIX

Not Applicable.

### FIELD OF THE INVENTION

This disclosure relates to the field of Microbial Electrochemical Cells (MECs), including MECs that may be utilized to desalinate and precipitate contaminant salts from saline water. The precipitate generated by this method includes the contaminant salts that were initially present in saline water. Thus, this method eliminates the production of brine as a waste by-product during saline water desalination. This method also reduces accumulation of contaminant ions in the anode and cathode chambers. At the same time, this method reduces the changes in pH in the anolyte and catholyte solutions during operation of MEC.

### BACKGROUND

The background section is described for the purpose of familiarizing the reader with several aspects of art that may be related to several characteristics of the present invention. This section is intended to familiarize the reader with background information to enhance the reader's understanding of several characteristics of the present invention. Therefore, the following statements are to be read in this light, and not as admissions of prior art.

Desalination of seawater has traditionally been an energy-intensive process that requires huge investments and generates waste by-products like brine which are not environmentally friendly. Usually, the generated brine is disposed of into the ocean which has raised serious concerns over its potential impacts on marine life and the environment. Conventional desalination technologies include distillation, reverse osmosis, and electrodialysis, all of which require high costs and generate brine.

When the apparatus and method of the present invention are embodied as a seawater desalination system, the major challenges of high costs, high energy input and generation of brine are drastically reduced. When contaminant salts in seawater, including Sodium Chloride and Magnesium Chloride, are precipitated as a result of this method, they can be easily separated in a dry solid form. These precipitated salts are economically worth more than the water which is desalinated by this method.

Since this apparatus and method employ MECs for desalination of seawater or other forms of saline water, electric current is generated during the desalination process instead of being consumed. This aspect considerably lowers the cost for desalination. MECs have gained significant attention recently for their potential to desalinate saline water using energy input requirements that are much lower than those of conventional desalination techniques. However, until now, MECs have not been industrially employed due to the various challenges they face in terms of low efficiency and pH instability. pH instability refers to the continuous decrease in the pH of the anolyte solution and continuous increase in the pH of the catholyte solution during the operation of MECs. Since a typical MEC houses anode-respiring microorganisms in its anode chamber, reduction in pH of the anolyte solution affects the metabolic processes of the microorganisms and consequently affects MEC performance. Moreover, in microbial desalination cells, which are a sub-category of MECs, the contaminant ions are removed from the saline water and transferred to the anode and cathode chambers where they get accumulated. This raises environmental concerns over the disposal of the spent anolyte and catholyte solutions.

However, when MECs are employed according to the apparatus and method of the present invention, the challenges of pH instability and contaminant accumulation in electrolyte solutions go away. This apparatus removes the H⁺ ions and OH⁻ ions from the electrode chambers while also removing the contaminant ions from the saline water. Moreover, the apparatus employs organic solvents in order to collect the contaminant ions. These contaminants are subsequently precipitated out of the solution.

One embodiment of this method can be used at the pre-treatment stage in desalination industries. Herein, the highly saline water results in greater current generation and greater desalination efficiency for MECs. Employing this method at the pre-treatment stage will save the high costs that are required to desalinate highly saline water using conventional desalination techniques such as reverse osmosis and distillation. One embodiment of this method can also be used to treat brine which is generated as a by-product of desalination industries. In addition to saving costs, these applications will generate electric current and precipitated contaminant salts in a dry solid form.

### SUMMARY

The objective of the invention is to significantly reduce the generation of byproducts such as brine or any solution containing water and contaminant salts during desalination. Another objective of the invention is to reduce pH instability in the anode and cathode chambers for MECs where the pH of the anolyte solution decreases, and pH of the catholyte solution increases during operation. Generation of precipitated contaminant salt, instead of brine, eliminates the environmental issues associated with desalination. Use of MECs for desalination can drastically reduce the economic barriers that prevent a more widespread use of desalination in developing countries. Moreover, stabilizing the pH in anolyte and catholyte solutions can make MECs more feasible for long-term operation and industrial applications.

This section provides several preferred embodiments and exemplary aspects of the present invention which are not intended to limit the scope of the invention. The invention may encompass a variety of aspects that may not be explicitly described herein. Changes herein will occur to those skilled in the art, which can be made without departing from the scope of the invention as described in the claims section.

The objectives of the present invention are achieved by providing an MEC. In one embodiment, the cell consists of an anode chamber containing an anolyte solution, an acid chamber containing an organic solvent and acids, a desalination chamber containing the saline water to be desalinated, an alkaline chamber containing an organic solvent and alkalis, and a cathode chamber containing a catholyte solution. Herein, each chamber is separated by ion-exchange membranes. The anode and cathode chambers contain an anode and a cathode electrode, respectively, wherein the electrodes are connected by an electric circuit. In some such embodiments, anode-respiring microorganisms present in the anode chamber generate an electric current. This electric current allows acids to accumulate in the acid chamber and alkalis to accumulate in the alkaline chamber. An outlet to the acid and alkaline chambers is mixed in a separate tank, where, the acids and alkalis combine to precipitate the contaminant salts in the organic solvent. The electrodes typically used in MECs are materials that are non-toxic to the anode-respiring microorganisms when the electrodes are disposed in chambers that also employ anode-respiring microorganisms. Exemplary non-toxic electrode materials include, but are not limited to, graphite fiber, graphite powder, carbon cloth, carbon felt, conductive polymer, conductive metal, and combinations thereof.

In certain embodiments, a first bipolar membrane is used to connect the anode chamber with the acid chamber and a second bipolar membrane is used to connect the cathode chamber with the alkaline chamber. The first bipolar membrane between the anode and acid chambers is placed such that the OH⁻ ions travel from the bipolar membrane towards the anode chamber and H⁺ ions travel from the bipolar membrane towards the acid chamber. The anode-respiring microorganisms release H⁺ ions inside the anode chamber as a result of their metabolic processes. Electrical neutrality and pH stability in the anode chamber are, therefore, achieved by transfer of OH⁻ ions from the bipolar membrane to the anode chamber. The second bipolar membrane between the cathode and alkaline chambers is placed such that the OH⁻ ions travel from the bipolar membrane towards the alkaline chamber and H⁺ ions travel from the bipolar membrane towards the cathode chamber. The type of catholyte employed inside in the cathode chamber should be such that it releases OH⁻ ions during operation of the cell. Electrical neutrality and pH stability in the cathode chamber are, therefore, achieved by transfer of H⁺ ions from the bipolar membrane to the cathode chamber.

In certain embodiments, bipolar membranes are not used in the cell. A cation exchange membrane is sandwiched between the anode chamber and the acid chamber and an anion exchange membrane are sandwiched between the cathode chamber and the alkaline chamber. The anode-respiring microorganisms release H⁺ ions inside the anode chamber as a result of their metabolic processes. Herein, electrical neutrality and pH stability in the anode chamber are achieved by the transfer of H⁺ ions from the anode chamber to the acid chamber through the cation exchange membrane. The type of an electron acceptor employed inside in the cathode chamber should be such that it releases OH⁻ ions during operation of the cell. Herein, electrical neutrality and pH stability in the cathode chamber are achieved by transfer of OH⁻ ions from the cathode chamber to the alkaline chamber through the anion exchange membrane. Herein, the anolyte solution constitutes chemicals such that the only cations present inside the anode chamber are H⁺ ions. An exemplary anolyte solution consists only of anode-respiring microorganisms and one or more substrates. Substrates are organic compounds that can be oxidized or decomposed by the microorganisms. Exemplary substrates include, but are not limited to, lipids, fats, carbohydrates, amino acids, proteins, municipal wastewater, and industrial wastewater. In some such embodiments, the catholyte solution comprises electron acceptor and chemicals such that the only anions present inside the cathode chamber are OH⁻ ions. An exemplary catholyte solution consists of oxygen sparged in an aqueous solution, in the presence of a platinum electrode, which releases OH⁻ ions as the only anions released inside the cathode chamber.

In certain embodiments, bipolar membranes are not used in the cell. A cation exchange membrane is used to connect the anode chamber with the acid chamber and an anion exchange membrane is used to connect the cathode chamber with the alkaline chamber. The anode-respiring microorganisms release H⁺ ions inside the anode chamber and these H⁺ ions transfer to the acid chamber through the cation exchange membrane to achieve electrical neutrality and pH stability in the anode chamber. In some such embodiments, the anode chamber consists of anode-respiring microorganisms, substrates, redox mediators, and/or additional pH buffers. Herein, some ionic species, besides H⁺ ions, are capable of traveling through the cation exchange membrane which separates the anode and acid chambers. All such ionic species are immobilized in the anode chamber. Alternatively, in some such embodiments, all such ionic species are adsorbed on solid surfaces of the electrode or other solid materials present in the anode chamber. An exemplary anolyte solution consists of anode-respiring microorganisms, substrates, and a hydrophilic redox mediator which is immobilized on the anode electrode. Exemplary redox mediators include but are not limited to, methylene blue, neutral red, methyl orange, potassium hexacyanoferrate, thionine, menadione, polypyrrole, anthraquinone-2,6-disulphate, cyanocobalamin, hydroxycobalamin, and 1,4-Dihydroxy-2-naphthoate derivatives. An exemplary pH buffer is a phosphate buffer solution comprising disodium hydrogen phosphate and sodium dihydrogen phosphate. Another exemplary pH buffer is a phosphate buffer solution comprising dipotassium hydrogen phosphate and potassium dihydrogen phosphate.

Various anode-respiring microorganisms can be used in the anode chamber such as prokaryotic organisms and eukaryotic organisms. In some embodiments, a mixed culture of microorganisms can be used in the anode chamber where the term ‘mixed culture’ refers to more than one species of microorganisms. In some such embodiments, at least one of the species of microorganisms is an anode-respiring microorganism. An example of a mixed culture of microorganisms comprises hydrogenotrophic methanogens, homoacetogens, which are not anode-respiring microorganisms, and some species of proteobacteria which are anode-respiring microorganisms. In some embodiments, anode-respiring microorganisms require anaerobic conditions inside the anode chamber. Anaerobic conditions can be achieved by sparging the anode chamber with an inert gas prior to the start of the operation of the MEC. Furthermore, any openings in the anode chamber should be covered throughout the operation of the MEC in order to prevent interaction of the anode-respiring microorganisms with an aerobic atmosphere. Exemplary inert gases that can be sparged into the anode chamber include, but are not limited to, nitrogen gas and argon gas.

The type of electron acceptor employed in the cathode chamber should be such that it releases OH⁻ ions during operation of the cell. Herein, electrical neutrality and pH stability in the cathode chamber are achieved by transfer of OH⁻ ions from the cathode chamber to the alkaline chamber through the anion exchange membrane. In some such embodiments, one or more species of microorganisms can be disposed inside the cathode chamber such that at least one of the species acts as an electron acceptor. In some such embodiments, where a plurality of microorganisms is disposed in the cathode chamber, the cathode chamber may additionally comprise substrates, redox mediators, and pH buffers in order to enhance the bioelectrochemical reactions and the transfer of electrons from the cathode electrode to the microorganisms. In all such embodiments, the cathode chamber may, additionally, contain anions, besides OH⁻ ions, that are present as reactants or products of the electrochemical or bioelectrochemical reduction reaction that takes place in the cathode chamber during operation of the cell. All such anions, besides OH⁻ ions, that are present in the cathode chamber are immobilized in the cathode chamber. Alternatively, in some such embodiments, all such anions, besides OH⁻ ions, are adsorbed on solid surfaces of the electrode or other solid materials present in the cathode chamber.

An exemplary electron acceptor is an electrochemically-active aqueous solution of potassium permanganate which is immobilized on the cathode electrode and is in contact with an aqueous solution of neutral pH in the cathode chamber. Exemplary microorganisms that can be used to drive bioelectrochemical reactions in the cathode chamber include, but are not limited to, Geobacter sulfurreducens, Shewanella oneidensis, nitrifying bacteria, denitrifying bacteria, and a naturally selected mixed culture of electrochemically active microorganisms obtained from industrial wastewater. In certain embodiments, the electron acceptor is disposed in the cathode chamber in a vapor state. An exemplary vapor state electron acceptor is Oxygen which is provided along with a Platinum electrode as the cathode electrode. In some embodiments, microorganisms that are disposed in the cathode chamber require anaerobic conditions inside the chamber. Anaerobic conditions can be achieved by sparging the cathode chamber with an inert gas prior to the start of the operation of the MEC. Furthermore, any openings in the cathode chamber should be covered throughout the operation of the MEC in order to prevent interaction of the microorganisms with an aerobic atmosphere. Exemplary inert gases that can be sparged into the cathode chamber include, but are not limited to, nitrogen gas and argon gas.

In some embodiments, a precipitate collection system is provided to generate precipitated contaminant salts from the effluents of the acid and alkaline chambers. In some such embodiments, the outlet to the acid and alkaline chambers is mixed in a separate tank, where, the acids and alkalis combine to precipitate the contaminant salts in the organic solvent. In some such embodiments, the outlet to this tank is connected to a conveyor belt through an auger. In some embodiments, other solid moving mechanisms included, but not limited to pumps, can be used to transport the outlet fluid from the tank to the conveyor belt.

Additional advantages and novel characteristics of the invention are provided in the following section of the brief description. Some of the additional advantages and novel characteristics will, in part, become apparent to those skilled in the art upon examination of the brief description or may be learned through experimentation or practice of the invention.

### BRIEF DESCRIPTION OF THE DRAWING

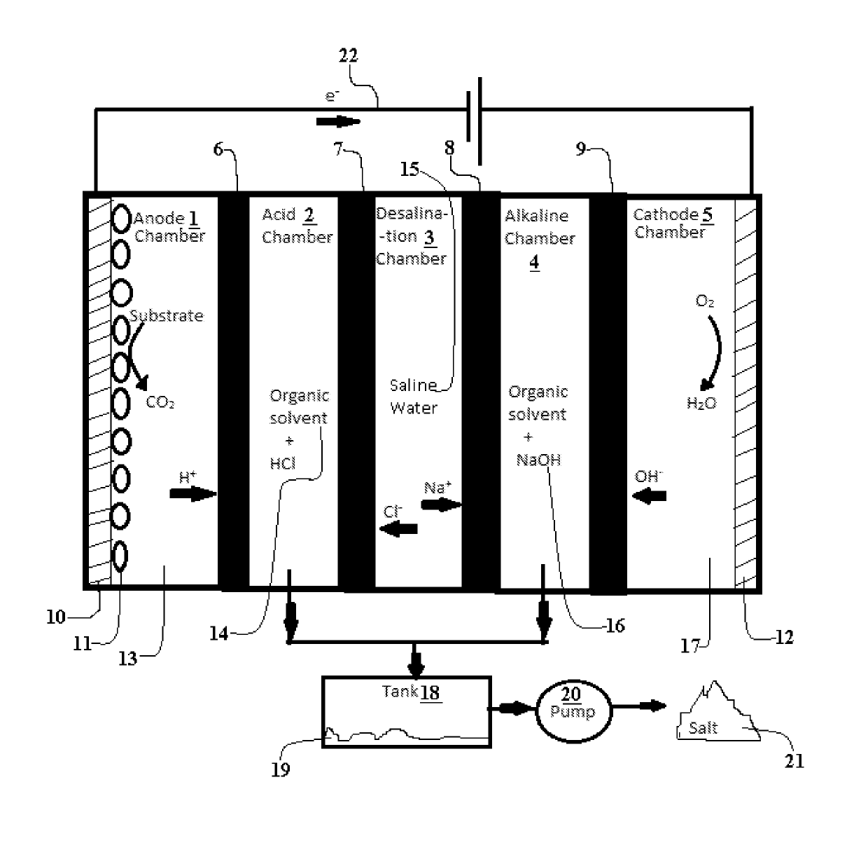

The invention is more fully appreciated in connection with the following detailed description taken in conjunction with FIG. 1. FIG. 1 is a diagrammatic vertical sectional view illustrating a five-chamber MEC configured in accordance with an embodiment of the invention. The structural elements identified by the reference numbers in FIG. 1 are as follows:
1. Anode chamber
2. Acid chamber
3. Desalination chamber
4. Alkaline chamber
5. Cathode chamber
6. Cation exchange membrane (CEM) or Bipolar membrane
7. Anion exchange membrane (AEM)
8. Cation exchange membrane (CEM)
9. Anion exchange membrane (AEM) or Bipolar membrane
10. Anode electrode
11. Biofilm of an anode-respiring microorganism
12. Cathode electrode
13. Anolyte solution
14. Solution in acid chamber
15. Saline water
16. Solution in alkaline chamber
17. Catholyte solution
18. Tank
19. Precipitated contaminant salt
20. Pump
21. Dry solid salt
22. Power supply

### DETAILED DESCRIPTION OF THE INVENTION

This disclosure provides MECs with direct salt recovery (MECDSR). An exemplary MECDSR enclosed herein includes an anode chamber 1, a cathode chamber 5, an anode electrode 10, a cathode electrode 12, a saline solution chamber 3, and two additional chambers for organic solvent: an acid chamber 2 and an alkaline chamber 4. The anode electrode 10 is disposed inside the anode chamber 1 which contains anode-respiring microorganisms 11. The microorganism forms a biofilm on the anode electrode. Alternatively, it may be immobilized on the electrode or suspended in the anolyte solution 13. The anode chamber 1 may be separated from the acid chamber 2 by a cation exchange membrane or a bipolar membrane 6. The acid 2 and alkaline 4 chambers consist of an organic solvent 14, 16 that has a high solubility for acids and alkalis but low solubility for the contaminant salts. 99% pure Ethanol is one such example of a suitable organic solvent. The acid 2 and desalination 3 chambers are separated by an anion-exchange membrane 7. The desalination chamber 3 comprises the saline water 15 which is a solution comprising contaminant ions that are to be desalinated. An exemplary saline water includes, but is not limited to, seawater, brine, wastewater, produced water, and/or combinations thereof. The desalination 3 and alkaline 4 chambers are separated by a cation-exchange membrane 8. The alkaline 4 and cathode 5 chambers are separated by an anion-exchange membrane or another bipolar membrane 9. The cathode chamber 5 contains the cathode electrode 12 and the catholyte solution 17.

The acid chamber 2 consists of an organic solvent 14. In some embodiments, the acid chamber 2 and the alkaline 4 chamber may additionally also consist of electrically conductive chemicals or materials. Concentrated HCl is one example of an electrically conductive chemical that can be added to the acid chamber to enhance the electrical conductivity of the organic solvent 14. Concentrated NaOH is one example of an electrically conductive chemical that can be added to the alkaline chamber to enhance the electrical conductivity of the organic solvent 15. Additionally, in some embodiments, the desalination chamber also comprises electrically conductive chemicals such that the electrical conductivity of the saline water is enhanced and MEC desalination efficiency is improved. Exemplary electrically conductive chemicals that can be added to the saline water include, but are not limited to, inorganic salts comprising sodium chloride and/or potassium chloride.

The anode chamber 1 consists of the anode-respiring microorganisms 11 and the substrates. During operation, some substrates provided in the anode chamber are oxidized by the microorganisms 11. These microorganisms 11 release electrons through their metabolic processes. Optionally, a redox mediator may be supplied in the anode chamber for shuttling the electrons provided by the microorganism to the anode electrode 10. The anode 10 and cathode electrodes 12 are connected via an external circuit 22. Concurrently, the cathode electrode 12 accepts the electrons from the external circuit 22. A suitable electron acceptor 17 in the cathode chamber can be used to accept electrons from the cathode electrode. However, the electron acceptor must be chosen such that the electrochemical reaction in the cathode chamber results in an accumulation of OH-anions in the cathode chamber.

As the electrochemical reactions in the anode 1 and cathode chambers 5 proceed, H⁺ ions accumulate inside the anode chamber 1 and OH⁻ ions accumulate inside the cathode chamber 5. If a bipolar membrane 6 is used between the anode and acid chamber. Then with sufficient potential, water at the bipolar membrane splits into OH⁻ and H⁺ ions where the OH⁻ ions travel towards the anode electrode, thus neutralizing the pH of the anolyte solution. The H⁺ ions travel from the bipolar membrane 6 towards the acid chamber 2 containing the organic solvent 14. Alternatively, if a cation-exchange membrane 6 is used between the anode chamber 1 and the acid chamber 2, then the H⁺ ions are accumulated inside the anode chamber 1 and travel through the cation-exchange membrane 6 towards the acid chamber 2 containing the organic solvent 14. Concurrently, contaminant anions in the desalination chamber 3, which contains a saline solution 15, travel towards the anode electrode 10 but get stopped in the acid chamber 2 by the cation-exchange membrane 6. Thus, the acid chamber 2 containing organic solvent accumulates H⁺ ions from the anode chamber 1 and contaminant anions from the desalination chamber 3, forming acids 14.

In a similar manner, contaminant cations in the desalination chamber 3 are attracted towards the cathode electrode 12 to maintain electrical neutrality, but they get stopped inside the alkaline chamber 4 by the anion-exchange membrane 9. The cathode chamber 9 accumulates OH⁻ anions which get attracted towards the anode electrode 10 but get stopped in the alkaline chamber 4 by the cation-exchange membrane 8. Thus, the alkaline chamber 4 accumulates OH⁻ anions from the cathode chamber 5 and the contaminant cations from the desalination chamber 3, forming alkalis 16.

In some embodiments, if the organic solvent used in the acid and alkaline chambers is soluble in water, then the organic solvent used must be of the highest purity that is feasible in order to eliminate the dissolution of acids and alkalis in the small proportion of water that is present along with the organic solvent. In certain embodiments, if the solubility of acids and alkalis in the preferred organic solvent is lower than that in water. Then, in order to avoid the precipitation of acids and alkalis in the acid and alkaline chambers, a higher quantity of the organic solvent can be used in the acid and alkaline chambers. However, in some such embodiments, if the width of the acid 2 and alkaline chambers 4 is too wide, internal resistance may increase which may impede the transfer of contaminant ions towards the acid and alkaline chambers. In such a scenario, the width of the acid and alkaline chambers should be kept at a thickness corresponding with the lowest feasible internal resistance of the cell. In some such embodiments, a larger quantity of organic solvent can be supplied in through acid and alkaline chambers of small thickness using continuous flow inlets and outlets.

Therefore, the effluent of the acid chamber contains organic solvent along with acids. It may also contain a slightly higher percentage of water due to the transport of some water molecules into the acid chamber through the ion-exchange membranes. Similarly, the effluent of the alkaline chamber contains organic solvent along with alkalis. It may also contain a slightly higher percentage of water due to the transport of some water molecules into the alkaline chamber through the ion-exchange membranes

In some embodiments, a precipitate collection system is provided to generate precipitated contaminant salts from the effluents of the acid and alkaline chambers. In some such embodiments, the effluents to the acid and alkaline chambers are mixed in a separate tank 18 wherein the acids and alkalis react to produce the contaminant salts. In certain embodiments, if this mixed solution is allowed to settle, the contaminant salts 19 precipitate out of the solution due to low solubility in the preferred organic solvent. Alternatively, precipitation can be achieved by distillation of the organic solvent if the preferred organic solvent has a low boiling point. In certain other embodiments, the contaminant salt can be separated from the organic solvent which is present in the tank 18 by use of conveyor belts. In some such embodiments, the outlet to the tank is connected to a conveyor belt through an auger. Alternatively, other mechanisms such as pumps 20, can be used to transport the outlet fluid from the tank to the conveyor belt.

The conveyor belt may receive a certain combination of the precipitated contaminant salt and the organic solvent. In certain embodiments, the conveyor belt may be used such that the precipitated contaminant salts are trapped by the belt and transported to the edge of the belt. In some such embodiments, the organic solvent may pass through the belt and get collected in a fluid tank and recycled back to the inlets of acid and alkaline chambers.

In some embodiments where bipolar membranes are employed, if the cell does not generate enough potential for water splitting at the bipolar membranes, then the reactions may, additionally, be driven by an external power source 22. Examples of external power sources include, but are not limited to, batteries, electrochemical cells, solar power, wind-generated power, other energy forms, and combinations thereof. In some embodiments of the invention, internal resistance may be reduced by ensuring the least feasible distance between the anode electrode and the cathode electrode.

Desalination processes according to embodiments of this disclosure include a batch operation of the anolyte, the catholyte, and the saline solutions. Alternatively, a continuous flow design can also be used for one or more of these solutions.

### EXAMPLE

In an exemplary embodiment, batch operation of an MECDSR is performed and operated as per FIG. 1. The anode chamber consisted of activated carbon cloth as the anode electrode. The anode electrode had a biofilm of microorganism, Saccharomyces cerevisiae. The anolyte solution consisted of 10 g/l of glucose as substrate. The cathode chamber consisted of activated carbon cloth as the cathode electrode. The catholyte solution consisted of 2 mg/l of KMnO₄ which is used as the electron acceptor. The desalination chamber consisted of seawater obtained from the Arabian Gulf at the coast of Sharjah, United Arab Emirates. The initial TDS of seawater was 40,000 ppm. The apparatus was operated for 24 hours during which the pH of the anolyte solution 13 changed negligibly from 3.75 to 3.7. The pH increase in the catholyte solution 17 was from 6.61 to 8. This increase in pH is very low compared to the increase in pH of catholyte solutions containing KMnO₄ and employed in conventional microbial desalination cells, where the pH increases drastically from 6.6 to 11.73. The final pH in the solution contained in the acid chamber was 2.1 due to the accumulation of acid from the neighboring chambers. The final pH in the solution contained in the alkaline chamber was 15.77 due to the accumulation of alkali from the neighboring chambers. The final TDS of the seawater that was to be desalinated was 37,000 ppm. This TDS reduction is moderate in comparison to desalination efficiencies of conventional microbial electrochemical systems in 24 hours. Thereafter, the solutions from the acid chamber 14 and the alkaline chamber 16 were mixed in a beaker. Within a few hours, salt had precipitated out of the organic solvent solution and weighed 500 mg.

1. A microbial electrochemical cell for recovering contaminant salts from saline water comprising:
an anode chamber, a desalination chamber comprising saline water, and a cathode chamber in which OH⁻ ions are generated; an anode electrode at least partially contained in the anode chamber; a cathode electrode at least partially contained in the cathode chamber with an electron acceptor at least partially in contact with the cathode electrode; and an electric circuit connecting the cathode electrode and the anode electrode;
the anode chamber comprising a plurality of anode-respiring microorganisms to oxidize substrates, transfer electrons through respiratory chains of the microorganisms, release electrons and H⁺ ions in the anode chamber, and generate an electric current between the cathode electrode and the anode electrode via the electric circuit;
an acid chamber between the anode chamber and the desalination chamber; an anion exchange membrane between the acid chamber and the desalination chamber; such that anions are transferred from the desalination chamber to the acid chamber due to an electric field established by the electric current;
an alkaline chamber between the cathode chamber and the desalination chamber; a cation exchange membrane between the alkaline chamber and the desalination chamber; such that cations are transferred from the desalination chamber to the acid chamber due to an electric field established by the electric current;
an organic solvent disposed in the acid chamber; the organic solvent having a lower solubility for one or more contaminant salts than their respective acids; an organic solvent disposed in the alkaline chamber; the organic solvent having a lower solubility for one or more contaminant salts than their respective alkalis.

2. The system of claim 1; wherein a cation exchange membrane or a bipolar membrane is sandwiched between the anode chamber and the acid chamber; an anion exchange membrane or a bipolar membrane is sandwiched between the cathode chamber and the alkaline chamber.

3. The system of claim 2; wherein the desalination chamber comprises seawater, brine, wastewater, produced water, or other solutions containing contaminant ions, or combinations thereof.

4. The system of claim 2; wherein the anode chamber or cathode chamber or both comprise one or more species of microorganisms.

5. The system of claim 4; further comprising microorganisms that are prokaryotic or eukaryotic, immobilized or non-immobilized or any combination of these forms.

6. The system of claim 5; wherein at least one species of microorganisms present in the anode chamber are anode-respiring microorganisms.

7. The system of claim 5; wherein the substrate comprises one or more organic compounds that can be oxidized or decomposed by the microorganisms disposed inside the anode chamber.

8. The system of claim 2; wherein the electron acceptor is immobilized or non-immobilized, is present in an aqueous state, or a vapor state, comprises one or more species of a plurality of microorganisms, or one or more electrochemically-active chemicals, or any combination of these forms.

9. The system of claim 2; wherein the electric current is generated from a combination of anode-respiring microorganisms and external power sources including batteries, electrochemical cells, solar power, wind-generated power, or other energy forms.

10. The system of claim 2; further comprising a plurality of redox mediators, pH buffer solutions, or combinations thereof in the anode and/or cathode chambers.

11. The system of claim 2; further comprising one or more electrically conductive chemicals in the acid chamber and/or the alkaline chamber.

12. The system of claim 2; further comprising one or more electrically conductive chemicals in the desalination chamber.

13. The system of claim 2; wherein a precipitate collection system is used to generate precipitated contaminant salts from the effluent solutions of the acid and alkaline chambers; the precipitate collection system comprising a tank, a conveyor belt, an auger, a pump, or a fluid tank or combinations thereof.
